(19) United States
(12) Patent Application Publication
(10) Pub. No.: US 2026/0079848 A1
(43) Pub. Date: Mar. 19, 2026

(54) DISTRIBUTED ADDRESS TRANSLATION SERVICES

(71) Applicant: Intel Corporation, Santa Clara, CA (US)

(72) Inventors: Shaopeng He, Shanghai (CN); Anjali Singhai Jain, Portland, OR (US); Yadong Li, Portland, OR (US); Israel Ben-Shahar, Jerusalem (IL); Rupin H. Vakharwala, Hillsboro, OR (US); Kun Tian, Shanghai (CN); Rashmi Hanagal Nagabhushana, Bangalore (IN); Andrzej Sawula, Gdansk (PL); Bartosz Pawlowski, Gdansk (PL); Brad A. Burres, Newton, MA (US)

(73) Assignee: Intel Corporation, Santa Clara, CA (US)

(21) Appl. No.: 19/107,813

(22) PCT Filed: Oct. 2, 2022
(86) PCT No.: PCT/CN2022/123674

§ 371 Date: Feb. 28, 2025

(51) Int. Cl. G06F 12/1009; G06F 12/1072; G06F 12/109

(52) U.S. Cl. CPC G06F 12/1009; G06F 12/1072; G06F 12/109

(57) ABSTRACT

A computing system including two or more processing units shares virtual memory for a program between the two or more processing units. Each of the processing units may include memory management circuitry to manage a respective page table corresponding to the virtual memory. A first portion of the addresses of the virtual address space of the program are mapped to addresses of physical memory associated with a first one of the two or more processing units, while a second portion of the addresses of the virtual address space are mapped to addresses in physical memory associated with a second one of the two or more processing units.

### FIELD

The present disclosure relates in general to the field of distributed computing systems, and more specifically, to data transfers within data center clusters.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

### BRIEF DESCRIPTION OF THE DRAWINGS

FIG. 1 illustrates a block diagram of components of a datacenter in accordance with certain embodiments.

FIG. 2A illustrates a simplified block diagram of an example computing system utilizing a link compliant with a Compute Express Link (CXL)-based protocol.

FIG. 2B illustrates a simplified block diagram of example protocol circuitry.

FIGS. 3A-3C are simplified block diagrams illustrating example device types within a Compute Express Link (CXL) infrastructure.

FIG. 4 is a simplified block diagram illustrating memory pooling using a CXL protocol.

FIG. 5 is a simplified block diagram illustrating an example data center cluster architecture.

FIG. 6 is a simplified block diagram illustrating data transfers within an example data center cluster architecture.

FIGS. 7A-7B are simplified block diagrams representing an example system including address translation services.

FIG. 8 is a simplified block diagram of an example system implementing a distributed virtual addressing architecture.

FIG. 9 is a simplified block diagram representing distribution of a virtual address space in accordance with one example.

FIG. 10 is a simplified block diagram showing example messaging within an example system supporting distributed address translation.

FIG. 11 is a simplified block diagram showing additional example messaging within an example system supporting distributed address translation.

FIG. 12 is a simplified block diagram of a first example heterogenous computing system.

FIG. 13 is a simplified block diagram of a second example heterogenous computing system.

FIG. 14 illustrates a block diagram of an example processor device in accordance with certain embodiments.

Like reference numbers and designations in the various drawings indicate like elements.

### DETAILED DESCRIPTION

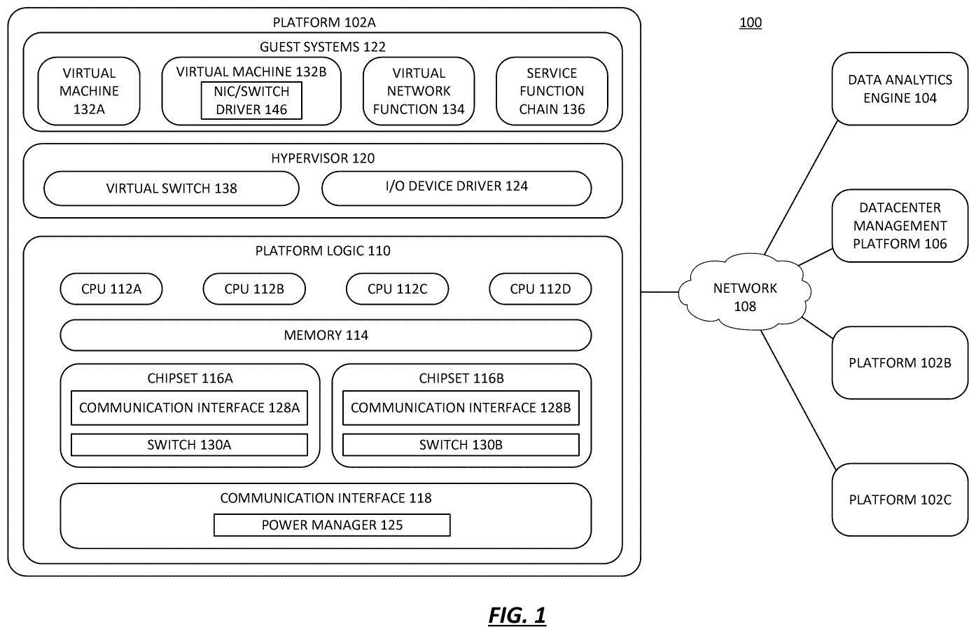

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such cluster more efficient, among other example enhancements.

Each platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may each comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on each CPU.

Chipsets 116 may each include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

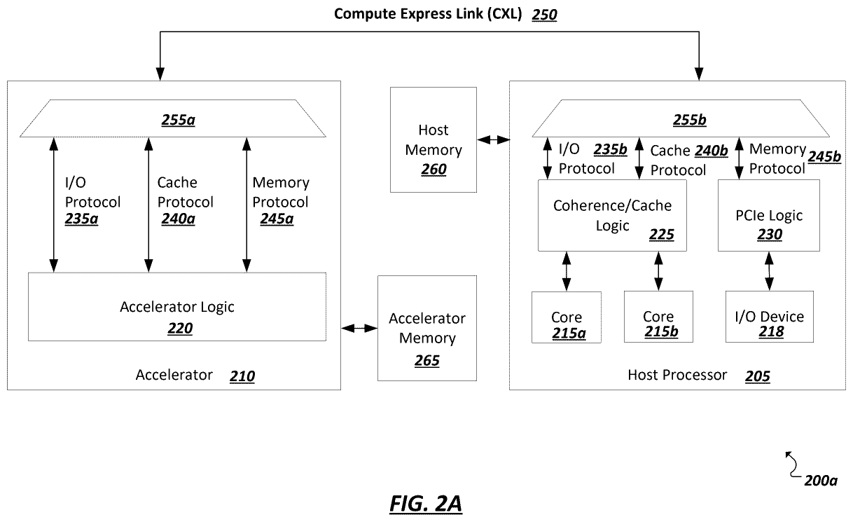

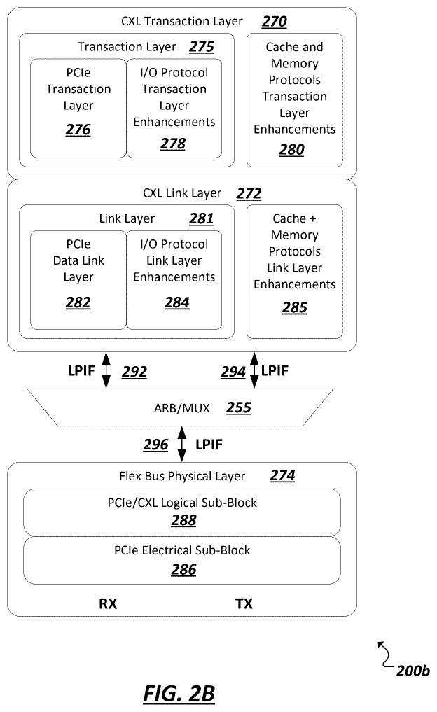

FIGS. 2A-2B are simplified block diagrams illustrating example protocol logic, implemented in hardware and/or software, to implement a Compute Express Link (CXL) protocol. It should be appreciated, that while much of the discussion centers on features provided by a CXL-protocol and communication channels compliant with CXL, that other substitute protocols with similar, comparable features may be substituted for CXL in the embodiments discussed below. The CXL interconnect protocol is designed to provide an improved, high-speed CPU-to-device and CPU-to-memory interconnect designed to accelerate next-generation data center performance, among other application. CXL maintains memory coherency between the CPU memory space and memory on attached devices, which allows resource sharing for higher performance, reduced software stack complexity, and lower overall system cost, among other example advantages. CXL enables communication between host processors (e.g., CPUs) and a set of workload accelerators (e.g., graphics processing units (GPUs), field programmable gate array (FPGA) devices, tensor and vector processor units, machine learning accelerators, networking accelerators, purpose-built accelerator solutions, among other examples). Indeed, CXL is designed to provide a standard interface for high-speed communications, as accelerators are increasingly used to complement CPUs in support of emerging computing applications such as artificial intelligence, machine learning and other applications.

A CXL link may be a low-latency, high-bandwidth discrete or on-package link that supports dynamic protocol multiplexing of coherency, memory access, and input/output (I/O) protocols. Among other applications, a CXL link may enable an accelerator to access system memory as a caching agent and/or host system memory, among other examples. CXL is a dynamic multi-protocol technology designed to support a vast spectrum of accelerators. CXL provides a rich set of sub-protocols that include I/O semantics similar to PCIe (CXL.io), caching protocol semantics (CXL.cache), and memory access semantics (CXL.mem) over a discrete or on-package link. Based on the particular accelerator usage model, all of the CXL protocols or only a subset of the protocols may be enabled. In some implementations, CXL may be built upon the well-established, widely adopted PCIe infrastructure (e.g., PCIe 5.0), leveraging the PCIe physical and electrical interface to provide advanced protocol in areas include I/O, memory protocol (e.g., allowing a host processor to share memory with an accelerator device), and coherency interface.

Turning to FIG. 2A, a simplified block diagram 200a is shown illustrating an example system utilizing a CXL link 250. For instance, the link 250 may interconnect a host processor 205 (e.g., CPU) to an accelerator device 210. In this example, the host processor 205 includes one or more processor cores (e.g., 215a-b) and one or more I/O devices (e.g., 218). Host memory (e.g., 260) may be provided with the host processor (e.g., on the same package or die). The accelerator device 210 may include accelerator logic 220 and, in some implementations, may include its own memory (e.g., accelerator memory 265). In this example, the host processor 205 may include circuitry to implement coherence/cache logic 225 and interconnect logic (e.g., PCIe logic 230). CXL multiplexing logic (e.g., 255a-b) may also be provided to enable multiplexing of CXL protocols (e.g., I/O protocol 235a-b (e.g., CXL.io), caching protocol 240a-b (e.g., CXL.cache), and memory access protocol 245a-b (CXL.mem)), thereby enabling data of any one of the supported protocols (e.g., 235a-b, 240a-b, 245a-b) to be sent, in a multiplexed manner, over the link 250 between host processor 705 and accelerator device 210.

In some implementations, a Flex Bus™ port may be utilized in concert with CXL-compliant links to flexibly adapt a device to interconnect with a wide variety of other devices (e.g., other processor devices, accelerators, switches, memory devices (e.g., near memory, far memory, pooled memory, tiered memory, cache, etc.), among other examples). A Flex Bus port is a flexible high-speed port that is statically configured to support either a PCIe or CXL link (and potentially also links of other protocols and architectures). A Flex Bus port allows designs to choose between providing native PCIe protocol or CXL over a high-bandwidth, off-package link. Selection of the protocol applied at the port may happen during boot time via auto negotiation and be based on the device that is plugged into the slot. Flex Bus uses PCIe electricals, making it compatible with PCIe retimers, and adheres to standard PCIe form factors for an add-in card.

FIG. 2B is a simplified block diagram 200b illustrating an example protocol stack and associated logic (implemented in hardware and/or software) utilized to implement CXL links. For instance, the protocol logic may be organized as multiple layers to implement the multiple protocols supported by the port. For instance, a port may include transaction layer logic (e.g., 270), link layer logic (e.g., 272), and physical layer logic (e.g., 274) (e.g., implemented all or in-part in circuitry). For instance, a transaction (or protocol) layer (e.g., 270) may be subdivided into transaction layer logic 275 that implements a PCIe transaction layer 276 and CXL transaction layer enhancements 278 (for CXL.io) of a base PCIe transaction layer 276, and logic 280 to implement cache (e.g., CXL.cache) and memory (e.g., CXL.mem) protocols for a CXL link. Similarly, link layer logic 272 may be provided to implement a base PCIe data link layer 282 and a CXL link layer (for CXI.io) representing an enhanced version of the PCIe data link layer 284. A CXL link layer 272 may also include cache and memory link layer enhancement logic 285 (e.g., for CXL.cache and CXL.mem).

Continuing with the example of FIG. 2B, a CXL link layer logic 272 may interface with CXL arbitration/multiplexing (ARB/MUX) logic 255, which interleaves the traffic from the two logic streams (e.g., PCIe/CXL.io and CXL.cache/CXL.mem), among other example implementations. During link training, the transaction and link layers are configured to operate in either PCIe mode or CXL mode. In some instances, a host CPU may support implementation of either PCIe or CXL mode, while other devices, such as accelerators, may only support CXL mode, among other examples. In some implementations, the port (e.g., a Flex Bus port) may utilize a physical layer 274 based on a PCIe physical layer (e.g., PCIe electrical PHY 286). For instance, a Flex Bus physical layer may be implemented as a converged logical physical layer 288 that can operate in either PCIe mode or CXL mode based on results of alternate mode negotiation during the link training process. In some implementations, the physical layer may support multiple signaling rates (e.g., 8 GT/s, 16 GT/s, 32 GT/s, etc.) and multiple link widths (e.g., x16, x8, x4, x2, x1, etc.). In PCIe mode, links implemented by the port may be fully compliant with native PCIe features (e.g., as defined in the PCIe specification), while in CXL mode, the link supports all features defined for CXL. Accordingly, a Flex Bus port may provide a point-to-point interconnect that can transmit native PCIe protocol data or dynamic multi-protocol CXL data to provide I/O, coherency, and memory protocols, over PCIe electricals, among other examples.

The CXL I/O protocol, CXL.io, provides a non-coherent load/store interface for I/O devices. Transaction types, transaction packet formatting, credit-based flow control, virtual channel management, and transaction ordering rules in CXL.io may follow all or a portion of the PCIe definition. CXL cache coherency protocol, CXL.cache, defines the interactions between the device and host as a number of requests that each have at least one associated response message and sometimes a data transfer. The interface consists of three channels in each direction: Request, Response, and Data.

The CXL memory protocol, CXL.mem, is a transactional interface between the processor and memory and uses the physical and link layers of CXL when communicating across dies. CXL.mem can be used for multiple different memory attach options including when a memory controller is located in the host CPU, when the memory controller is within an accelerator device, or when the memory controller is moved to a memory buffer chip, among other examples. CXL.mem may be applied to transaction involving different memory types (e.g., volatile, persistent, etc.) and configurations (e.g., flat, hierarchical, etc.), among other example features. In some implementations, a coherency engine of the host processor may interface with memory using CXL.mem requests and responses. In this configuration, the CPU coherency engine is regarded as the CXL.mem Master and the Mem device is regarded as the CXL.mem Subordinate. The CXL.mem Master is the agent which is responsible for sourcing CXL.mem requests (e.g., reads, writes, etc.) and a CXL.mem Subordinate is the agent which is responsible for responding to CXL.mem requests (e.g., data, completions, etc.). When the Subordinate is an accelerator, CXL.mem protocol assumes the presence of a device coherency engine (DCOH). This agent is assumed to be responsible for implementing coherency related functions such as snooping of device caches based on CXL.mem commands and update of metadata fields. In implementations, where metadata is supported by device-attached memory, it can be used by the host to implement a coarse snoop filter for CPU sockets, among other example uses.

In some implementations, an interface may be provided to couple circuitry or other logic (e.g., an intellectual property (IP) block or other hardware element) implementing a link layer (e.g., 272) to circuitry or other logic (e.g., an IP block or other hardware element) implementing at least a portion of a physical layer (e.g., 274) of a protocol. For instance, an interface based on a Logical PHY Interface (LPIF) specification to define a common interface between a link layer controller, module, or other logic and a module implementing a logical physical layer (“logical PHY” or “logPHY”) to facilitate interoperability, design and validation re-use between one or more link layers and a physical layer for an interface to a physical interconnect, such as in the example of FIG. 2B. Additionally, as in the example of FIG. 2B, an interface may be implemented with logic (e.g., 281, 285) to simultaneously implement and support multiple protocols. Further, in such implementations, an arbitration and multiplexer layer (e.g., 255) may be provided between the link layer (e.g., 272) and the physical layer (e.g., 274). In some implementations, each block (e.g., 255, 274, 281, 285) in the multiple protocol implementation may interface with the other block via an independent interface (e.g., 292, 294, 296). In cases where bifurcation is supported, each bifurcated port may likewise have its own independent interface, among other examples.

CXL is a dynamic multi-protocol technology designed to support accelerators and memory devices. CXL provides a rich set of protocols. CXL.io is for discovery and enumeration, error reporting, peer-to-peer (P2P) accesses to CXL memory and host physical address (HPA) lookup. CXL.cache and CXL.mem protocols may be implemented by various accelerator or memory device usage models. An important benefit of CXL is that it provides a low-latency, high-bandwidth path for an accelerator to access the system and for the system to access the memory attached to the CXL device. The CXL 2.0 specification enabled additional usage models, including managed hot-plug, security enhancements, persistent memory support, memory error reporting, and telemetry. The CXL 2.0 specification also enables single-level switching support for fan-out as well as the ability to pool devices across multiple virtual hierarchies, including multi-domain support of memory devices. The CXL 2.0 specification also enables these resources (memory or accelerators) to be off-lined from one domain and on-lined into another domain, thereby allowing the resources to be time-multiplexed across different virtual hierarchies, depending on their resource demand. Additionally, the CXL 3.0 specification doubled the bandwidth while enabling still further usage models beyond those introduced in CXL 2.0. For instance, the CXL 3.0 specification provides for PAM-4 signaling, leveraging the PCIe Base Specification PHY along with its CRC and FEC, to double the bandwidth, with provision for an optional flit arrangement for low latency. Multi-level switching is enabled with the CXL 3.0 specification, supporting up to 4K Ports, to enable CXL to evolve as a fabric extending, including non-tree topologies, to the Rack and Pod level. The CXL 3.0 specification enables devices to perform direct peer-to-peer accesses to host-managed device memory (HDM) using Unordered I/O (UIO) (in addition to memory-mapped I/O (MMIO)) to deliver performance at scale. Snoop Filter support can be implemented in Type 2 and Type 3 devices to enable direct peer-to-peer accesses using the back-invalidate channels introduced in CXL.mem. Shared memory support across multiple virtual hierarchies is provided for collaborative processing across multiple virtual hierarchies, among other example features.

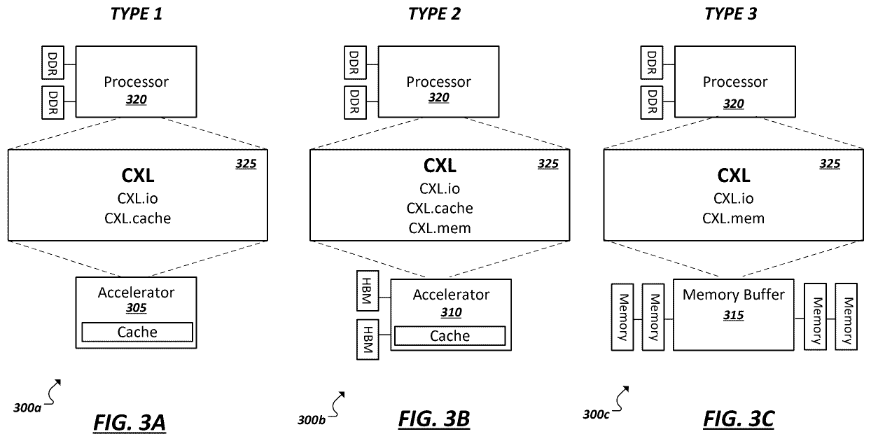

CXL is a high-performance I/O bus architecture that is used to interconnect peripheral devices that can be either traditional non-coherent I/O devices, memory devices, or accelerators with additional capabilities. When Type 2 and Type 3 device memory is exposed to the host, it is referred to as Host-managed Device Memory (HDM). The coherence management of this memory may be Host-only Coherent (HDM-H), Device Coherent (HDM-D), and Device Coherent using Back-Invalidation Snoop (HDM-DB). The host and device must have a common understanding of the type of HDM for each address region. FIGS. 3A-3C are simplified block diagrams 300a-c showing examples of CXL Type 1 devices (e.g., 305), Type 2 devices (e.g., 310), and Type 3 devices (e.g., 315). A CXL device (e.g., 305, 310, 315) may couple to a host processor (e.g., 320) via a CXL interconnect 325. Different CXL device types may utilize different combinations of the CXL protocols (or sub-protocols) (e.g., CXL.io, CXL.mem, CXL.cache).

In CXL, a “Type 1” devices have special needs for which having a fully coherent cache in the device becomes valuable. For such devices, standard producer-consumer ordering models do not work well. One example of a device with special requirements is to perform complex atomics that are not part of the standard suite of atomic operations present on PCIe. Basic cache coherency allows an accelerator to implement any ordering model it chooses and allows it to implement an unlimited number of atomic operations. These tend to require only a small capacity cache which can easily be tracked by standard processor snoop filter mechanisms. The size of cache that can be supported for such devices depends on the host's snoop filtering capacity. CXL supports such devices using its optional CXL.cache link over which an accelerator can use CXL.cache protocol for cache coherency transactions.

CXL “Type 2” devices, in addition to fully coherent cache, also have memory, for example DDR, High-Bandwidth Memory (HBM), or other memory attached to the device. These devices execute against memory, but their performance comes from having massive bandwidth between the accelerator and device-attached memory. One goal for CXL is to provide a means for the Host to push operands into device-attached memory and for the Host to pull results out of device-attached memory such that it does not add software and hardware cost that offsets the benefit of the accelerator. Systems may include coherent system address-mapped device-attached memory, also referred to as HDM with Device Managed Coherence (HDM-D/HDM-DB). There is an important distinction between HDM and traditional I/O and PCIe Private Device Memory (PDM). An example of such a device is a GPGPU with attached GDDR. Such devices have treated device-attached memory as private. This means that the memory is not accessible to the Host and is not coherent with the remainder of the system. It is managed entirely by the device hardware and driver and is used primarily as intermediate storage for the device with large data sets. A disadvantage to a model such as this is that it involves high-bandwidth copies back and forth from the Host memory to device-attached memory as operands are brought in and results are written back. Please note that CXL does not preclude devices with PDM.

At a high level, there are two example approaches of resolving device coherence of HDM. The first uses CXL.cache to manage coherence of the HDM and is referred to as “Device coherent.” The memory region supporting this flow is indicated with the suffix of “D” (HDM-D). The second approach uses the dedicated channel in CXL.mem called Back Invalidation Snoop and is indicated with the suffix “DB” (HDM-DB). With HDM-DB, the protocol enables new channels in the CXL.mem protocol that allow direct snooping by the device to the host using a dedicated Back-Invalidation Snoop (BISnp) channel. The response channel for these snoops is the Back-Invalidation Response (BIRsp) channel. The channels allow devices the flexibility to manage coherence by using an inclusive snoop filter tracking coherence for individual cache lines that may block new M2S Requests until BISnp messages are processed by the host.

A CXL “Type 3” device supports CXL.io and CXL.mem protocols. An example of a CXL Type 3 Device is a memory expander for the Host. Since this is not a traditional accelerator that operates on host memory, the device does not make any requests over CXL.cache. A passive memory expansion device would use the HDM-H memory region and while not directly manipulating its memory while the memory is exposed to the host. The device operates primarily over CXL.mem to service requests sent from the Host. The CXL.io protocol is used for device discovery, enumeration, error reporting and management. The CXL.io protocol is permitted to be used by the device for other I/O-specific application usages. The CXL architecture is independent of memory technology and allows for a range of memory organization possibilities depending on support implemented in the Host. Type 3 device Memory that is exposed as an HDM-DB enables the device to directly manage coherence with the host to enable in-memory computing and direct access using UIO on CXL.io. A Type 3 Multi-Logical Device (MLD) can partition its resources into up to multiple (e.g., 16) isolated Logical Devices. Each Logical Device may be identified by a Logical Device Identifier (LD-ID) in CXL.io and CXL.mem protocols. Each Logical Device visible to a Virtual Hierarchy (VH) operates as a Type 3 device. The LD-ID is transparent to software. MLD components have common Transaction and Link Layers for each protocol across all LDs.

CXL is capable of maintaining memory coherency between the CPU memory space and memory on attached devices, so that any of the CPU cores or any of the other I/O devices configured to support CXL may utilize these attached memories and cache data locally on the same. Further, CXL allows resource sharing for higher performance, such that memory pooling may be achieved across different computing entities. Such CXL-enabled memory pools may enable enhanced and more efficient movement of operands. For instance, rather than utilizing DMA operation to transfer an entire segment of data from one computing element to the next computing element in association with a corresponding operation, coherent memory allows data to be moved seamlessly as if it were a simple transfer between the different cores in different CPU sockets. Such memory pooling can thus realize significant latency reduction and enable this aggregated memory in the system. Such features can enable more efficient memory usage, reduced architectural complexity, and thereby lower overall system costs. Further, such features allow programmers and system developers to focus on target workloads as opposed to redundant memory management, among other example benefits.

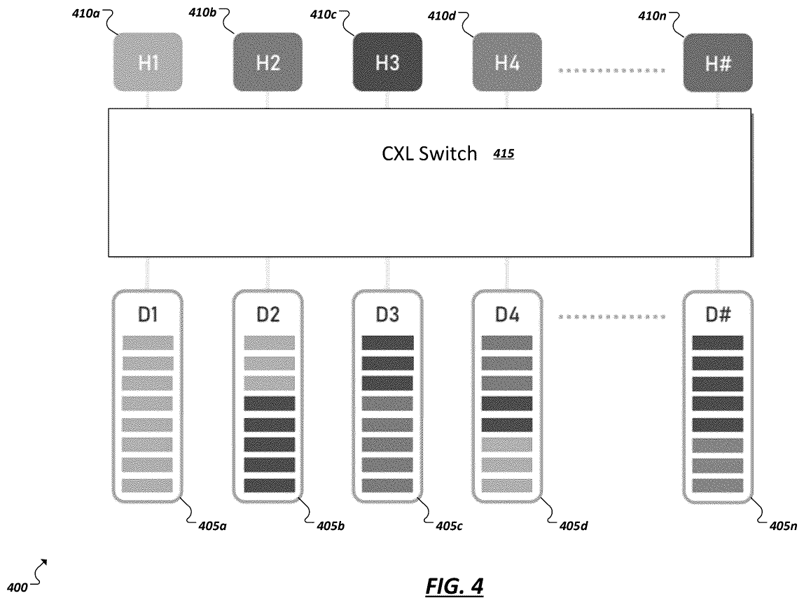

FIG. 4 is a simplified block diagram 400 illustrating the example pooling of multiple devices 405a-n (e.g., logical type 2 devices) to multiple host devices 410a-m. CXL (e.g., CXL 2.0) enables such pooling utilizing a CXL switch 415 (with a standardized CXL Fabric manager 418), where the memory on the devices 405a-n can be assigned to or shared with different hosts (e.g., 410a-m) and can be changed over time. The CXL switch 415 supports multiple hosts and is responsible for ensuring quality of service as well as isolation between different hosts. Other implementations, may utilize processing-in-memory (PIM) within their systems or cluster, including logic-in-memory or near-data processing. PIM technology aims to bring memory and computing closer instead of separating them, thus, improving the efficiency of data movement. Traditional PIM systems, however, may struggle with data coherence issues, as both a host processor and PIM processing can handle and compete for data, among other example issues.

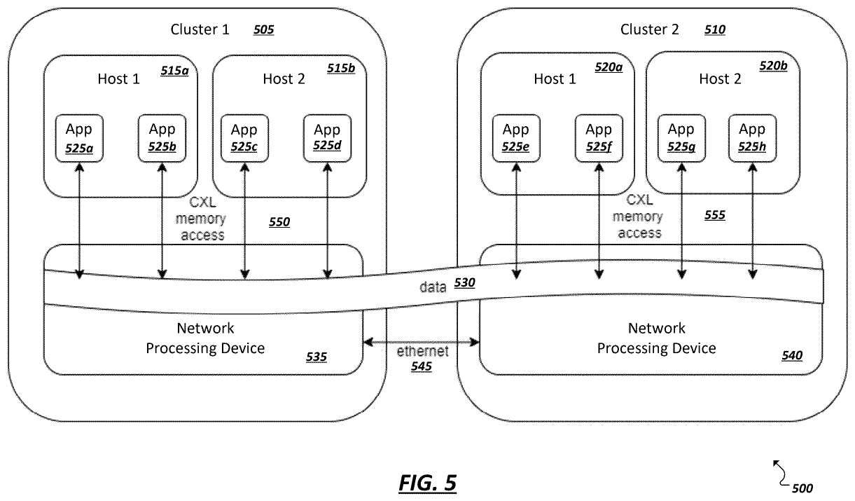

Improved node or cluster architectures may leverage the combined features of CXL and smart network processing devices (e.g., infrastructure processing units (IPUs)) to develop more efficient and better-performing service mesh clusters, which achieve these efficiencies with minimal movement of networking data and enhanced near memory processing. Such improved clusters can realize smaller latency, better resources utilization, and lower power consumption, among other example benefits. FIG. 5 is a simplified block diagram 500 illustrating a logical view of such a portion of such an improved cluster. As introduced above, a service mesh can be composed of one or multiple clusters (e.g., 505, 510). Host devices (e.g., 515a, 515b, 520a, 520b, etc.) may each host various programs, services, or applications (e.g., 525a-h), which are executed on the corresponding host and which may share and operate various data on the service mesh. All of the data 530 moving within the cluster may be handled using the corresponding cluster's network processing device (e.g., 535, 540), with the network processing device further handling the inter-cluster communications and the internal connections of hosts and the network processing device within the cluster. Attached memory of the network processing device may be utilized to implement a memory pool for the cluster. Accordingly, data used in transactions within the cluster may be saved in the memory pool on the network processing device. Accordingly, when host device accesses the data within a transaction, the host device can utilize CXL memory accesses (e.g., 550, 555) to directly read or write data through the CXL cached memory as if it were local memory.

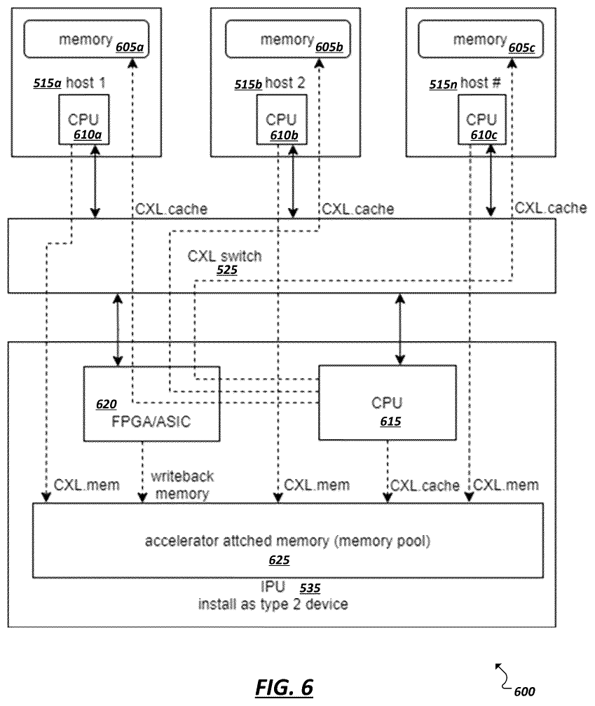

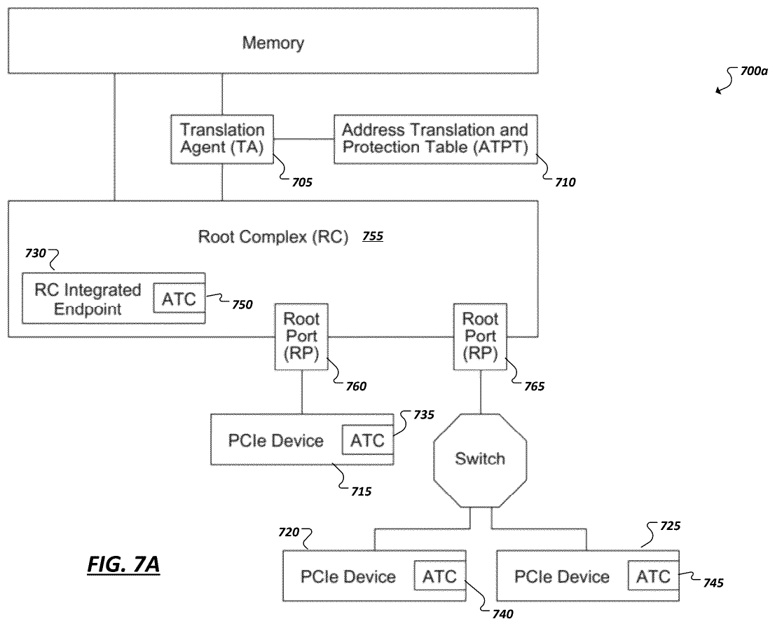

Turning to FIG. 6, a simplified block diagram 600 illustrating example hardware blocks of components within a cluster, such as the example shown in FIG. 5. For instance, each host device (e.g., 515a-n) may include respective local or attached memory (e.g., 605a-c) as well respective processing hardware 610a-c (e.g., CPU, FPGA, GPU, tensor processing unit (TPU), accelerator hardware, etc.), which may be utilized to host and execute various applications or portions of applications on the corresponding host. Each of the host devices 515a-c may be connected to a CXL switch 525 for the cluster. The network processing device 535 of the cluster is also coupled to the switch 525. The network processing device 535 may include both a CPU 615 and programmable processing block 620 (e.g., a field programmable gate array (FPGA) or application-specific integrated circuit (ASIC)), together with attached memory 625, at least a portion of which is designated for use as a memory pool for the cluster.

In one example implementation, the network processing device 535 may be installed as a CXL type 2 device. Accordingly, the CPUs (e.g., 610a-c) of the hosts 515a-c, as well as the CPU (e.g., 615) of the network processing device 535, can cache (e.g., perform cacheable reads and cacheable writes of) the attached memory of the network processing device 535 using the CXL.mem subprotocol. The programmable processing block 620 of the network processing device 535 may cache the hosts' attached memory (e.g., 605a-c) using the CXL.cache subprotocol. Further, a dedicated hardware channel may be provided between the CPU 615 and programmable processing block 620 of the network processing device 535, allowing the CPU 615 to access the hosts' memories (e.g., 605a-c) through the programmable processing block 620 (e.g., also using the CXL.cache subprotocol), among other example features and implementations.

Workloads handled by distributed computing architectures also continue to evolve. New workloads and applications challenge traditional data center assumptions and architectures. As an example, the increasing popularity of and innovations pertaining to machine learning, artificial intelligence, and training machine learning models and hardware used in such applications have spurred the development of new computing architectures to handle corresponding workloads. Cloud computing and data center environments have been targeted to handle such workloads and the corresponding data. However, evolving machine learning and tensor processing workloads may be vastly different workloads and require processing and memory infrastructure divergent from that relied upon to handle other more traditional applications, among other example issues.

In addition to changing the priorities of legacy interconnect architectures, the migration to distributed and heterogenous computing systems also introduces new challenges and opportunities as it pertains to how data is shared within a system, including the management of address translations involving requests on memory used to store this data. For instance, in conventional PCIe architectures, all virtual memory is hosted by the host CPU device in an interconnected system, which may additionally include multiple PCIe device coupled to the host CPU via a root port and corresponding PCIe links. More recently, advanced devices have been developed which allow private memory sharing through memory-mapped I/O (MMIO), such as controller memory buffers of an NVMe device. As introduced above, CXL standardizes memory pooling and sharing to allow flexible device memory sharing inside the fabric. However, for virtual addressing, all endpoints in a PCIe fabric still depend on the root complex to provide virtual memory and address translation. A PCIe root complex includes the sole input output memory management unit (IOMMU) to serve all address translation requests for virtual addresses to physical addresses within its PCIe system. This centralized address translation node, however, becomes a bottle neck for the entire PCIe fabric, which may become especially onerous in systems attempting to utilize PCIe/CXL for heterogeneous computing.

More particularly, in the case of traditional PCIe architectures, provisions are made to translate address from direct memory access (DMA) (bus mastering I/O functions. Address translation, in PCIe is handled exclusively by the root complex of the host, with all address translation requests directed to the root port. Accordingly, in traditional PCIe systems, the only address transaction logic and supporting translation structures are provided at the host system. For instance, addresses programmed into an I/O Function act as a “handle” to be processed by the Root Complex (RC). The address is then translated by the RC into a physical memory address within the central complex. In some cases, the processing includes access rights checking to ensure that the requesting function (e.g., DMA function) is allowed to access the referenced memory location(s). However, memory access time can be significantly lengthened due to the time required to complete said translations to the actual physical address. To mitigate these impacts, some PCIe implementations provide for address translation caches. For instance, in a CPU, the address translation cache is often referred to as a translation look-aside buffer (TLB). For an I/O translation agent (TA) of a RC, the term address translation cache (ATC) is used to differentiate it from the translation cache used by the CPU. While there are some similarities between TLB and ATC, there are important differences. A TLB serves the needs of a CPU that is nominally running one thread at a time. The ATC, however, is generally processing requests from multiple I/O functions, each of which can be considered a separate thread.

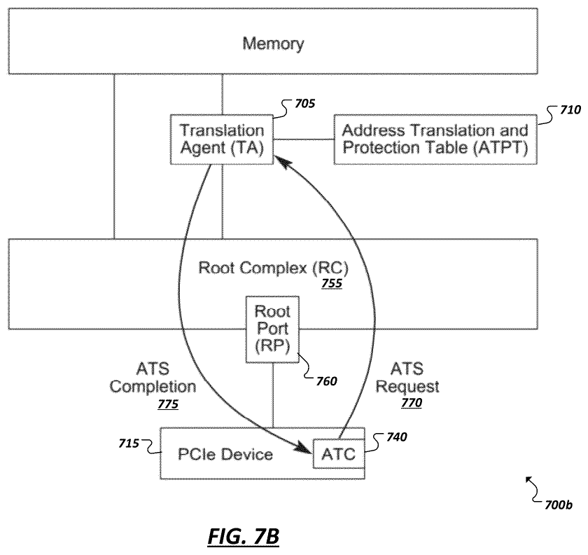

PCIe provides for ATCs to be provided at the I/O device to allow the I/O device to participate in the translation process and provide an ATC for its own memory accesses. Turning to the simplified block diagram 700a of FIG. 7A, an example platform is shown with a TA 705 and address translation and protection table (ATPT) 710, along with a set of PCIe devices (e.g., 715, 720, 725) and root complex integrated endpoints 730 with integrated ATC (e.g., 735, 740, 745, 750). A TA 705 and an ATPT 710 can be distinct or integrated components within a given system design. The PCIe devices may be coupled to the root complex 755 via respective root ports 760, 765. PCIe defines an Address Translation Service (ATS) that builds upon the PCIe base specification by providing a set of transaction layer packets (TLPs) for use in request and responses in address translations. PCIe ATS uses a request-completion protocol between devices (e.g., 715, 720, 725, 730, etc.) and the root complex 755 to provide translation services. Further, ATS provides for an address translation field in PCIe memory reads and write TLPs to identify to the RC whether the corresponding request has been translated or not via the ATS protocol.

Turning to FIG. 7B, a simplified block diagram 700b is shown illustrating the example flow defined in a PCIe ATS translation request operation. The PCIe device generates an ATS translation request 770 which is sent upstream through the PCIe hierarchy to the root complex 755, which processes the request using TA 705. The ATS translation request 770 uses the same routing and ordering rules as defined in PCIe. Upon receipt of the ATS translation request 770, the TA 705 validates that the requesting function has been configured to issue ATS translation requests and determines whether the function may access the memory indicated by the ATS translation request 770 and has the associated access rights. If validated, the TA 705 may determine whether a translation can be provided to the function. If so, the TA issues a translation to the function and communicates the success or failure of the request to the root complex 755. The root complex 755 then generates an ATS translation completion and transmits the completion via a response TLP 775 through a root port 760 to the PCIe device 715. When the PCIe device 715 receives the ATS translation completion response 775, the PCIe device 715 updates its ATC 740 (unless the completion indicated that a translation does not exist). The PCIe Device 715 may determine that caching a translation within its ATC (e.g., 740) would be beneficial, such as by determining that the translation corresponds to memory address ranges that will be frequently accessed over an extended period of time or that are used to store important data structures used in the function, among other examples. Upon receiving a translated address, the function may then use the physical address returned in the completion to proceed with processing its work request. A PCIe ATS translation request (e.g., 770) or translation completion (e.g., 775) are similar to PCIe Read Request and Read Completion (e.g., to reduce design complexity in the integration of ATS into the PCIe protocol).

As can be appreciated from the illustrations in the examples of FIGS. 7A-7B, conventional PCIe architecture's reliance on the host CPU (and root complex) as the single server of address translation for virtual addressing may compromise performance of a system, especially as distributed applications become more popular and involve execution across a number of processing devices (or “XPU”s), including heterogenous XPUs (e.g., graphics processing units (GPUs), IPUs, data processing units (DPUs), tensor processing units (TPUs), etc.). For instance, within a PCIe hierarchy, only one XPU (with the root complex) is permitted to provide such translation services. This becomes a bottle neck for all XPUs inside the PCIe fabric, and very inconvenient for heterogeneous computing developers who are unable to fully leverage the more robust features of the other XPUs (e.g., their own attached memory (e.g., RAM).

In an improved architecture, rather than relying on a single XPU to provide address translation for an entire system or hierarchy, a distributed translation service may be implemented for a PCIe or CXL fabric. Such a distributed translation model migrates the programming and architectural paradigm from a CPU-centric model to a memory-centric model, which may be particularly advantageous in heterogenous computing architectures. Indeed, in some example heterogenous systems, some of the other XPUs (those XPUs without the root complex) may already be provisioned with translation logic, such as IOMMU blocks, which go unused and wasted in traditional PCIe architectures, among other example issues.

For instance, in implementations of a PCIe or CXL fabric interconnecting two or more processing devices, or XPUs, address translation services may be distributed such that local memory, and even pooled, or fabric-attached, memory (e.g., facilitated through CXL memory pooling) the XPU considers its own may be utilized as virtual memory space. In this manner, virtual memory can be “shared” between multiple XPUs, with each of these multiple XPUs providing address translation logic and hosting address translation structures (e.g., page tables, translation lookaside buffers, etc.) that may be leveraged to serve translation services to processes within the interconnected system. In some instances, principles of PCIe ATS may be leveraged, such as the ATS Device Process Information feature and the ATS translation request-response model, which may be expanded to support new distributed address translation requests and responses, among other example features. The virtual address space within the system, as seen by each process (e.g., of distributed applications configured to run in the system (e.g., using the multiple XPUs' resources), may be divided into “regions”, with the local memory of a given XPU being used as a portion, or region, of the overall physical memory mapped to virtual address space. The mapping of XPUs to the multiple regions may be maintained by a centralized manager for the system. In some cases, XPU address-to-region mappings may be maintained and broadcast (or otherwise communicated) by the host XPU (e.g., with the root complex) to other devices in the system, which may be submitting translation requests to the multiple XPUs providing distributed address translation services. One XPU can act as the address translation server for one region of one virtual address space (e.g., for a process denoted by a Process Address Space ID (PASID). Other devices can request address translation for the various regions based on the region-to-XPU address mapping.

Distributed address translation removes the virtual address translation bottle neck from the host CPU as in conventional PCIe and CXL hierarchies. Instead, multiple XPUs within the fabric effectively share their virtual memory with each other. This meaningfully changes current heterogeneous computing from a host-device model to independent XPU-XPU model, which may be leveraged by next generation development kits tuned to working with such distributed, heterogeneous architectures.

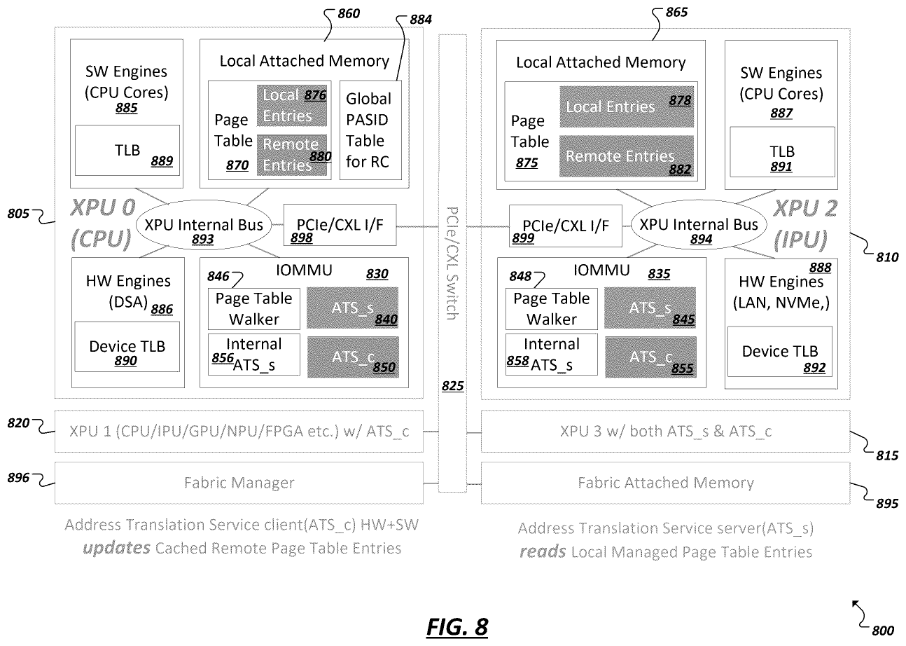

FIG. 8 is a simplified block diagram 800 of an example system including multiple XPU devices 805, 810, 815, 820 interconnected by a fabric 825 utilizing PCIe and/or CXL links. At least two of the XPU devices (e.g., 805, 810) may be provided with virtual address translation logic, implemented, for instance, in hardware circuitry, to implement a distributed address translation scheme for the system. For instance, an XPU (e.g., 805, 810) can include an IOMMU (e.g., 830, 835), which is enhanced to include both distributed address translation server (ATS_s) logic (e.g., 840, 845) and distributed address translation client (ATS_c) logic (e.g., 850, 855). The IOMMU may also include page table walking logic (e.g., 846, 848) to perform page table walks of page tables (e.g., 870, 875). When a process requests a translation of a virtual address to a physical address, it may send a translation request to its local IOMMU, which uses internal address translation service logic (e.g., 856, 858) to read its local page table to determine the translation. If the local page table does not include the translation for the requested virtual address (e.g., in the case of a page fault), the IOMMU may use its distributed address translation logic to query the ATS_s logic of other XPUs for the translation.

Each of the distributed-address-translation-service-enabled XPUs (e.g., 805, 810) may have local attached memory 860, 865, which may be loaded with one or more page tables (e.g., 870, 875) for various processes. Example page tables (e.g., 870, 875) for use in a distributed address translation architecture may include local entries (e.g., 876, 878) and remote entries (e.g., 880, 882). Local entries (e.g., 876) may be mappings of pages in virtual address space to addresses of pages locally stored in the local attached memory (e.g., 860) of the XPU (e.g., 805), while remote entries (e.g., 880) map other page in the virtual address space to the memory (e.g., 865) of other XPUs (e.g., 810) also participating in the distributed translation of the virtual address space. One of the participating XPUs (e.g., 805) may also include in its memory centralized mappings and data structures for use in the distributed address translation architecture, such as a global PASID table (corresponding to a root complex (RC)) 884 a mapping of XPU addresses to regions defined in the distributed virtual address scheme, among other example information.

In the distributed address translation logic (e.g., the IOMMU) of an XPU, the XPU may have a translation service client (ATS_c) and a translation service server (ATS_s). The translation service server (e.g., 840, 845) handles and reads the local entries (e.g., 876, 878) of its page table (e.g., 870, 875) over which it has full visibility and control. The translation service client (e.g., 850, 855) rely on information from other XPUs in the distributed address translation scheme to provide mappings of virtual address space in other regions and effectively caches and updates this information (based on the responses from the other XPUs governing these other regions of the virtual address space) in the remote entries (e.g., 880, 882) of their respective page tables (e.g., 870, 875). While XPUs (e.g., 805, 810, 815) in the system may be provided with both distributed address translation server logic (for the regions it governs) and distributed address translation client logic, other XPUs (e.g., 820) may be provided with distributed address translation client logic only to simply consume the shared virtual memory hosted on local memory of the other XPUs.

XPUs may include one more blocks (e.g., 885, 886, 887, 888) of processing hardware. For instance, a CPU (e.g., 805) may include hardware implementing software engines (e.g., 885), such as CPU cores, and hardware engines (e.g., 886) (e.g., data streaming accelerator (DSA) circuitry). As another example, an XPU may be implemented as an IPU (e.g., 810) and CPU cores may implement the software engines (e.g., 887), while hardware engines include local area network (LAN), non-volatile memory (e.g., NVMe) and other hardware logic, among other examples. Processing hardware (e.g., 885-888) may be provided with respective translation lookaside buffers (TLBs) (e.g., 889, 890, 891, 892) for use with the page tables (e.g., 870, 875). The components of the XPU may be interconnect with an internal bus (e.g., 893, 894) as well as interfaces (e.g., 898, 899) to the system fabric 825. In one example, internal ATS_s logic may service requests from local ATS clients. Hardware engines may first attempt to utilize the translation services on the local platform, which may utilize the page table walker to find the physical address from the page tables local or remote entries. If unsuccessful using the local ATS_s, the hardware engine may then utilize the distributed address translation protocol (e.g., implemented using PCIe ATS) to query another XPU's ATS_s logic.

As introduced above, fabric protocols, such as CXL, may be utilized to facilitate memory pooling and sharing within the system. Portions of the respective memory connected within the system by the fabric 825 may be allocated for use in a CXL memory pool. Various XPUs may be permitted access to the CXL memory pool and may regard at least a portion (or all) of the pooled memory as “local” memory using the protocol. Such pooled memory may be physically located on or attached to the XPUs or as separate devices (e.g., accelerator attached memory, memory extension devices, etc.). Such pooled memory may be referred to as “fabric-attached” memory (e.g., 895). In some implementations, a system entity, or fabric manager 896, may be provided or defined (e.g., implemented by another device in the system) to manage fabric-attached memory 895. For instance, an XPU participating in a distributed address translation implementation may regard fabric-attached memory as its own local memory and may, in some implementations, map a portion of the distributed virtual address space to memory physically located on remote devices but in fabric-attached memory 895. Not only can an XPU map their virtual memory addresses to the physical addresses belonging to fabric-attached memory, but in some implementations, an XPU may even map its virtual address to another XPU's local attached memory, among other potential implementations.

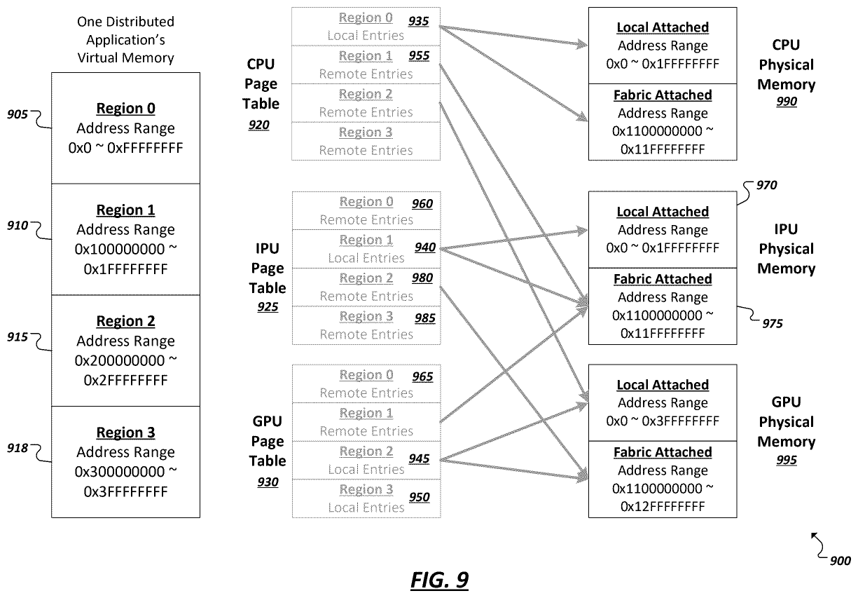

FIG. 9 is a block diagram 900 illustrating a representation of the distribution of virtual memory within a system, such as introduced in the examples above. In this particular example, virtual memory is distributed between three XPUs: a CPU, an IPU, and a GPU. A particular program or process may have a virtual address space. The system (e.g., as governed by system software) may subdivide virtual address space into multiple distributed portions, or regions. For instance, a first address range may be designated as Region 0 (905), a second address range may be designated as Region 1 (910), a third address range as Region 2 (915), and a fourth address range as Region 3 (918). In one example, the leading or most significant byte(s) of a virtual address may indicate which region the virtual address belongs (e.g., address 0x200001234 is Region 2, whereas address 0x0001234 is in Region 1, etc.). Each region may be assigned to, or owned, by a respective one of the XPUs (e.g., the CPU, IPU, and GPU) participating in distributed virtual address translation of the system implementation. In this particular example, Region 0 is assigned to the CPU, Region 1 is assigned to the IPU, and Regions 2 and 3 are assigned to the GPU.

Given this, the example of FIG. 9 also illustrates representations of the respective page tables (e.g., 920, 925, 930) of the CPU, IPU, and GPU respectively. Each XPU manages the local virtual-to-physical address mappings for its region, with the physical addresses corresponding to the XPU's own locally attached memory and/or allocation of fabric-attached memory. Accordingly, each page table 920, 925, 930 includes a set of local page table entries (e.g., 935, 940, 945, 950) that identify the XPU's local virtual-to-physical address mappings for its region. Each of the page tables 920, 925, 930 may also include remote page table entries (e.g., 955, 960, 965, etc.) which identify mappings (e.g., defined at the remote XPU governing that region) of other portions of the virtual address space that map to the local memory of that remote XPU. As an example, for the IPU's page table 925, the page table's mapping of virtual addresses included in Region 1 (owned by the IPU) are considered local entries, as they are visible and managed by the IPU given that these virtual addresses are mapped to physical addresses in physical memory controlled by the IPU, such as locally attached memory (e.g., 970) and/or fabric-attached memory (e.g., 975). Remote entries (e.g., 960, 980, 985) correspond to mappings of virtual addresses to physical memory of other XPUs (e.g., the CPU and GPU) and define mappings to the respective physical memories (e.g., 990, 995) of these other XPUs. The IPU does not control or manage these other XPUs' memories and can only query/request information pertaining to these mappings from the other XPUs (e.g., mappings of these other region's virtual addresses (e.g., page addresses) to the other XPUs physical memories) and update the corresponding remote entries in the IPU's page table 925 based on this information. In this sense, the remote entries serve more as mapping caches of the regions owned by other XPUs in the distributed address translation architecture. Likewise, the other XPUs' page tables (e.g., 920, 930) may be organized and used in like manner.

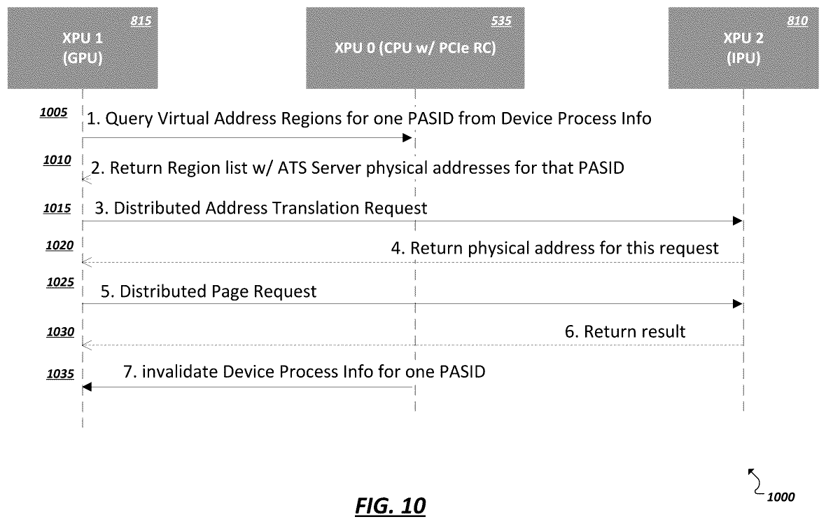

Turning to FIG. 10, a simplified flow diagram 1000 is shown illustrating example messaging that may be defined (e.g., in the PCIe or CXL specification) to facilitate distributed address translation. In this example, XPU 0 (805), such as a CPU with a PCIe root complex, serves as an administrator of the distributed address translation architecture, using its root complex, for instance, to manage and communicate which regions (of a process's virtual address space) are owned by which XPUs (e.g., 805, 810, 815) in the system. In one example, each XPU (e.g., GPU 815) may send a regions query 1005 to the CPU 805 to determine, for a corresponding PASID of the process, what regions of the PASID's virtual address are to be owned by which XPUs in the system. This query need only occur once for each PASID. In some cases, different XPUs (e.g., 805, 810, 815) in the system may own different regions within different PASID's virtual addresses. The CPU 805 may receive and process the region query 1005 and return a region list (at 1010) to the GPU 815 to indicate (e.g., by the respective addresses of the various XPU address translation servers), which XPUs own which regions of the process's address space. With this information, the GPU can understand which other XPUs' address translation servers should be solicited (e.g., using the GPU's address translation client) when an address translation request is to be sent regarding a virtual address in a region owned by another one of the XPUs (e.g., CPU 805 or IPU 810).

Continuing with the example of FIG. 10, to update remote entries in its page table for the PASID, the GPU 815 may send a distributed address translation request 1015 for one or a block of pages. The request 1015 may be sent based on the GPU 815 first identifying, from the region listing, that translation for a given range of virtual addresses corresponding to one of the regions is to be handled (and is owned by) IPU 810. Accordingly, to obtain mappings or updates of mappings of virtual addresses in the IPU's region(s) and the local physical memory of the IPU, the GPU 815 may send one or more distributed address translation requests 1015. In some implementations, the distributed address translation request 1015 may be implemented as a PCIe request message, similar to PCIe ATS requests. In response to the distributed address translation request 1015, the IPU's 810 address translation server logic may read from its local entries and return a response 1020 indicating the requested virtual address-to-physical address mapping at the IPU. The GPU's address translation client may receive the response 1020 and update corresponding remote entries within its page table for the PASID.

With these mappings updated, the GPU's distributed address translation logic may be utilized to perform page walks of local and remote entries within its page table and return address mappings for the process (e.g., for storage in a TLB associated with execution of at least a portion of the process corresponding to the PASID). Further, the page table may be utilized to fetch corresponding pages (in association with execution of the process) from the local memory of the IPU. For instance, in the event that a page fault is identified (e.g., at the IPU 810), a page the GPU 815 may send a distributed page request 1025 to the IPU 810. In turn, the IPU may return a result (over the fabric interconnecting the GPU and IPU) as a response 1030 to the GPU 810, among many other examples. Using remote entries in the page table, a GPU may fetch pages stored in remote physical memory (e.g., of the IPU 810). Further, in some implementations, additional messaging may be defined with a distributed address translation architecture. For instance, if there is a change in the assignment of regions within a virtual address space, such as a change to the address of a particular XPU's address translation server, the XPU managing such assignments (e.g., CPU 805) may send an assignment invalidate message (e.g., 1035) or other information to advertise such changes to the participating XPUs, to ensure the XPUs continue to address the correct XPUs for virtual addresses associated with other XPUs' assigned regions, among other example features, protocols, and message exchanges.

In one example implementation, in connection with the implementation of a distributed address translation service architecture, new messages or packets may be defined within a corresponding interconnect protocol. For example, in a PCIe implementation of distributed address translation, new messages or packets may be defined for distributed address translation requests, distributed address translation responses, and page request messages, among other examples. TABLE 1 illustrates examples of such new messages and their respective implementation details:

TABLE 1
Distributed Address Translation Messages for PCIe/CXL

| TLP Name | Message Code | Description |
|---|---|---|
| Distributed ATS Request | 0000 0110 | Message TLP type is MsgD, routing type is |
| | | Routed by Address (001). |
| | | Page Address field in the header has the value of |
| | | ATS server address, and payload is 64 bits of |
| | | virtual address to be translated. |
| Distributed ATS | 0000 0111 | Message TLP type is MsgD, routing type is |
| Response | | Routed by Address (001) |
| | | The Page Address field in the header has the value |
| | | of ATS server address, and payload is 64 bits of |
| | | translated physical address. |
| Enhanced Page Request | 0000 0100 | add Routed by Address (001) for Routing option |
| Message | | and MsgD for Type bits. |
| | | If Type is Msg, it is traditional PRS. |
| | | If Type is MsgD, it is Distributed PRS; the |
| | | original Page Address field has the value of ATS |
| | | server address, and the payload is 64 bits of |
| | | virtual address for requested page. |
| Page Response Message | 0000 0101 | no change to the message itself, but for |
| | | Distributed ATS, it may come from other devices |
| | | rather than only from Root Complex for |
| | | traditional ATS. |

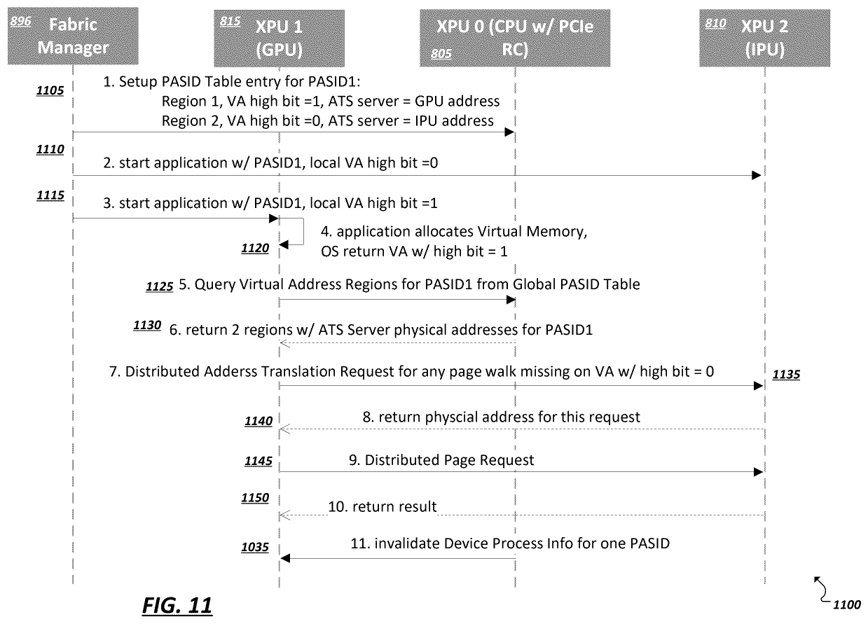

FIG. 11 is another simplified flow diagram 1100 shown illustrating example messaging for use in a distributed address translation scheme. As introduced above, in some implementations, fabric-attached memory, such as implemented as CXL pooled memory, may be utilized by XPUs in a distributed address translation architecture as physical memory to which the shared virtual memory is to be mapped. As fabric-attached memory may not physically be local to an XPU in the literal sense, the XPU may nonetheless consider portions of the fabric-attached memory as its own to which it may map virtual addresses (in local entries of its page table for a process). In some implementations, a fabric manager entity (e.g., 896) may be utilized to assist in configuring XPUs' use and mappings to fabric-attached memory. Further, in some implementations, a fabric manager 896 may also be utilized to assist in configuring the assignment of regions of virtual memory for a particular process (identified by its PASID).

For instance, for a particular PASID, the fabric manager 896 may assign a first region to IPU 810 and a second region to GPU 815 (among other regions of the process's virtual address space, which may be assigned. These region assignments may be communicated 1105 to the CPU 805 responsible for managing region assignment queries for the system. The fabric manager 896 may also be used to initiate the process on XPUs in the system, such as starting the corresponding application on the IPU (at 1110), as well as on GPU 815 (at 1115). Starting the program may cause the allocation of virtual memory on the corresponding XPU. For instance, in the case of GPU 815, an operating system (e.g., at the request of the application) may allocate (at 1120) virtual addresses from its own range, which the GPU may use to populate local entries of its corresponding copy of the application's page table. The GPU may then use a process, similar to that described and illustrated in the example of FIG. 10 to populate the remote entries of the page table by querying the other XPUs assigned to other regions of the virtual memory. For instance, the GPU may query 1125 the CPU 805 for a mapping of regions-to-XPUs, which the CPU may return 1130. Using this information, the GPU 815 may determine that IPU corresponds to one or more of the regions and submit distributed address translation requests (e.g., 1135) to the IPU to obtain mappings pertaining to the regions owned by the IPU 810 (e.g., via response 1140). Using the updates received from other XPUs, the GPU may build its page table for this process and utilize the page table to identify the addresses of remote pages and send requests for these pages. The XPU (e.g., 815) may also identify and attempt to resolve page faults (e.g., corresponding to earlier distributed translation requests) at other remote XPUs participating the distributed address translation architecture by sending distributed page requests (e.g., 1145). The response 1150 may then identify the physical address of the requested page. The returned physical addresses may then be used to fetch the corresponding pages from remote memory.

In some implementations of a distributed address translation architecture, kernel page table entries may be separated into two types: local managed and remote cached. If a page fault happens on remote cached page, fault handler may react by sending a distributed ATS request or distribute Page Request to the page owner in a similar manner as devices. In some implementations, much of an IOMMU subsystem and ATC subsystem from legacy implementations may be kept unchanged, except for adding support of messages targeted to various distributed address translation servers hosted on different devices, as opposed to solely addressing a default root complex.

In memory centric architectures, local attached memory for each XPU and fabric-attached memory may be cohesively managed as part of the overall system orchestration. Such orchestration may be performed by an orchestration system includes the management system and control agent for a local operating system (OS) of each participating XPU. In some implementations, policies may be defined and enforced to ensure that these underlayer systems and XPU hardware are trusted. Security may be restricted to the applications and user/tenant. In one example implementations, a unified security policy may be pushed to every XPU concerning specific applications and make sure all the risks are mitigated in end-to-end fashion, among other example security solutions, which may be implemented in a distributed address translation system.

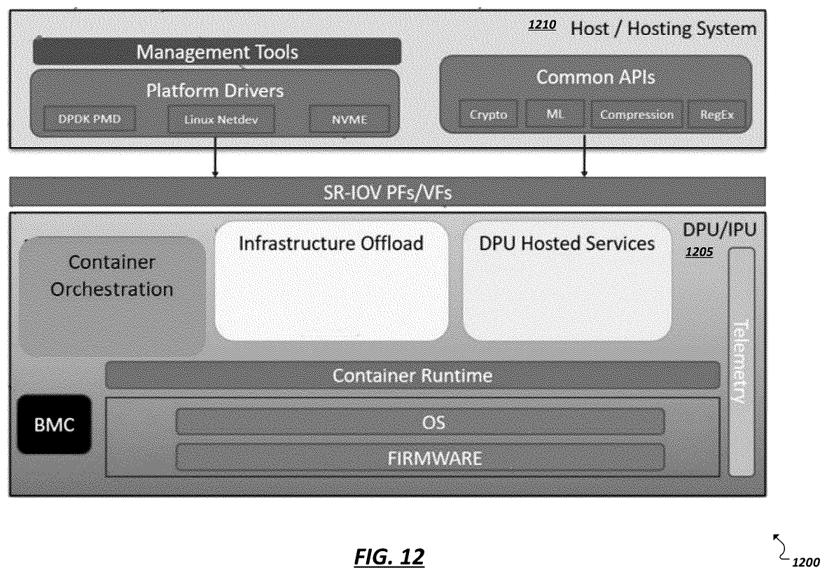

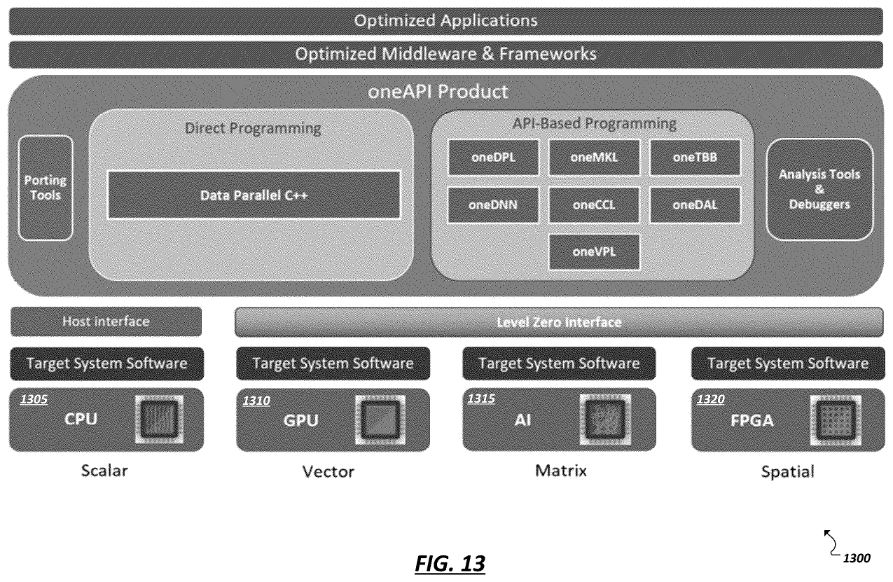

As alluded to above, distributed address translation architectures may be favorably deployed within modern and emerging distributed and heterogenous computing platforms. FIGS. 12-13 are simplified block diagrams illustrating particular example systems including multiple XPUs in which such distributed address translation features may be implemented and supported. Providing distributed address translation can assist with making XPU devices more independent of the host (rather than more of a peripheral device, which uses the host virtual address in the PCIe fabric or cannot take the benefits of local PCIe fabric, etc.). For instance, the example of FIG. 12 shows a system 1200 that allows an IPU or DPU (e.g., 1205) application to access other acceleration devices, such as a GPU (e.g., without using assistance from the host 1210). In this example, a CPU for the system supports device process information, including device-to-region mapping, where the IPU or DPU supports at least distributed address translation server mode, and the GPU supported distributed address translation client mode.

In another example, illustrated in FIG. 13, a system 1300 implementing a memory centric architecture is illustrated. For instance, CXL may be used to implement a single unified physical memory for a PCIe-fabric-based heterogeneous computing environment. Distributed address translation serves to also unify the virtual memory crossing tall XPUs of the system involved in one task or process (e.g., with the same PASID). This may result in heterogeneous computing behaving more like multiple threads programming in a Non-Uniform Memory Access (NUMA) environment. Such a system may represent a profound change from current heterogeneous computing from a host-device model to an independent XPU-XPU model. For instance, in this example, the root complex XPU (e.g., 1305) may again support ATS device process info (to map XPUs to regions), and each of the XPUs (e.g., 1305, 1310, 1315, 1320) may support distributed address client and server modes, among other illustrative examples.

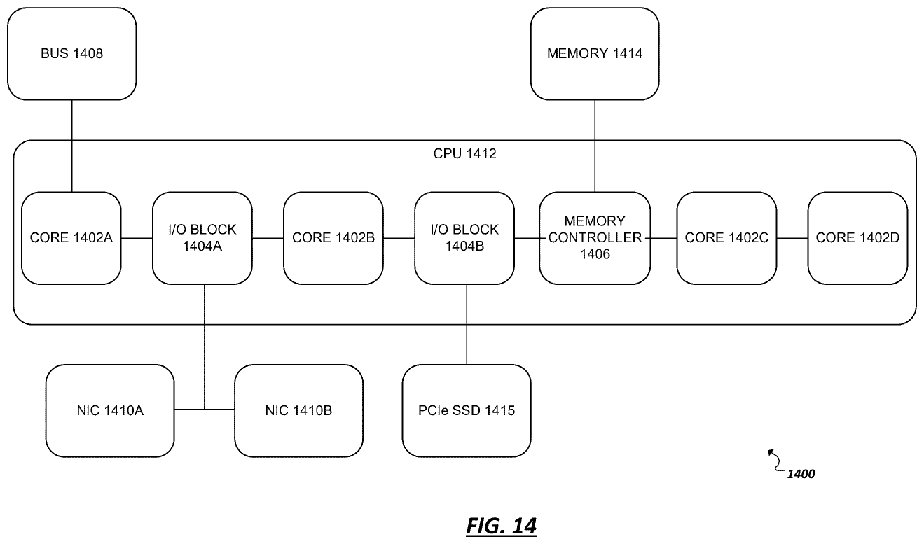

Note that the apparatus′, methods′, and systems described above may be implemented in any electronic device or system as aforementioned. As a specific illustration, FIG. 14 provides an exemplary implementation of a processing device such as one that may be included in a network processing device. It should be appreciated that other processor architectures may be provided to implement the functionality and processing of requests by an example network processing device, including the implementation of the example network processing device components and functionality discussed above. Further, while the examples discussed above focus on the use of CXL and CXL-based resource pooling and the application of PCIe ATS protocol, it should be appreciated that reference to PCIe and CXL are offered merely as reference examples. Indeed, the more generalized concepts disclosed herein may be equally and advantageously applied to other interconnects and interconnect protocols, as well as alternative systems and computing platforms, among other examples.

Referring to FIG. 14, a block diagram 1400 is shown of an example data processor device (e.g., a central processing unit (CPU)) 1412 coupled to various other components of a platform in accordance with certain embodiments. Although CPU 1412 depicts a particular configuration, the cores and other components of CPU 1412 may be arranged in any suitable manner. CPU 1412 may comprise any processor or processing device, such as a microprocessor, an embedded processor, a digital signal processor (DSP), a network processor, an application processor, a co-processor, a system on a chip (SOC), or other device to execute code. CPU 1412, in the depicted embodiment, includes four processing elements (cores 1402 in the depicted embodiment), which may include asymmetric processing elements or symmetric processing elements. However, CPU 1412 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1412, as illustrated in FIG. 14, includes four cores-cores 1402A, 1402B, 1402C, and 1402D, though a CPU may include any suitable number of cores. Here, cores 1402 may be considered symmetric cores. In another embodiment, cores may include one or more out-of-order processor cores or one or more in-order processor cores. However, cores 1402 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1402 may include a decode module coupled to a fetch unit to decode fetched elements. Fetch logic, in one embodiment, includes individual sequencers associated with thread slots of cores 1402. Usually a core 1402 is associated with a first ISA, which defines/specifies instructions executable on core 1402. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 1402 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1402, in one embodiment, recognize the same ISA (or a subset thereof). Alternatively, in a heterogeneous core environment, a decoder of one or more cores (e.g., core 1402B) may recognize a second ISA (either a subset of the first ISA or a distinct ISA).

In various embodiments, cores 1402 may also include one or more arithmetic logic units (ALUs), floating point units (FPUs), caches, instruction pipelines, interrupt handling hardware, registers, or other suitable hardware to facilitate the operations of the cores 1402.

Bus 1408 may represent any suitable interconnect coupled to CPU 1412. In one example, bus 1408 may couple CPU 1412 to another CPU of platform logic (e.g., via UPI). I/O blocks 1404 represents interfacing logic to couple I/O devices 1410 and 1415 to cores of CPU 1412. In various embodiments, an I/O block 1404 may include an I/O controller that is integrated onto the same package as cores 1402 or may simply include interfacing logic to couple to an I/O controller that is located off-chip. As one example, I/O blocks 1404 may include PCIe interfacing logic. Similarly, memory controller 1406 represents interfacing logic to couple memory 1414 to cores of CPU 1412. In various embodiments, memory controller 1406 is integrated onto the same package as cores 1402. In alternative embodiments, a memory controller could be located off chip.

As various examples, in the embodiment depicted, core 1402A may have a relatively high bandwidth and lower latency to devices coupled to bus 1408 (e.g., other CPUs 1412) and to NICs 1410, but a relatively low bandwidth and higher latency to memory 1414 or core 1402D. Core 1402B may have relatively high bandwidths and low latency to both NICs 1410 and PCIe solid state drive (SSD) 1415 and moderate bandwidths and latencies to devices coupled to bus 1408 and core 1402D. Core 1402C would have relatively high bandwidths and low latencies to memory 1414 and core 1402D. Finally, core 1402D would have a relatively high bandwidth and low latency to core 1402C, but relatively low bandwidths and high latencies to NICs 1410, core 1402A, and devices coupled to bus 1408.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a first processor device; first physical memory to store a page table associated with a virtual address space of a process, where a first portion of the virtual address space is mapped to the first physical memory and a second portion of the virtual address space is mapped to a second physical memory of a second processor device; a memory management unit including: an address translation client to: send a distributed address translation request to a second processor device, where the distributed address translation request identifies a second virtual memory address associated with the process; receive a response to the distributed address translation request, where the response to the distributed address translation request identifies that a second physical memory address of a second physical memory associated with the second processor device is mapped to the second virtual memory address; and add a mapping of the second virtual memory address to the second physical memory address in the page table.

Example 2 includes the subject matter of example 1, where the memory management unit further includes: an address translation server to: receive a request to translate a first virtual memory address in the first portion of the virtual address space into a physical address of the first physical memory; determine, from the page table, a mapping of the first virtual memory address to a first physical memory address of the first physical memory; and return the first physical memory address as a response to the request.

Example 3 includes the subject matter of any one of examples 1-2, where the first physical memory address addresses a first page of data within the first physical memory, and the second physical memory address addresses a second page of data within the second physical memory.

Example 4 includes the subject matter of any one of examples 1-3, where the first processor device and the second processor device are interconnected in a distributed computing architecture, and virtual memory for the computing architecture is distributed between memory of at least the first processor device and the second processor device.

Example 5 includes the subject matter of example 4, where the distributed computing architecture includes pooled memory shared within the distributed computing architecture, and the memory of the first processor device includes the first physical memory and at least a portion of the pooled memory.

Example 6 includes the subject matter of example 4, where the pooled memory includes memory resources from a plurality of devices in the distributed computing architecture and is implemented using a Compute Express Link (CXL)-based protocol.

Example 7 includes the subject matter of any one of examples 1-6, where the first processor device is associated with a first region of virtual address space of the process and the second processor device is associated with a second region of virtual address space of the process, where a first portion of virtual addresses in the virtual address space of the process are included in the first region, a second portion of virtual addresses in the virtual address space of the process are included in the second region, where physical memory of the processor is mapped to the first portion of virtual addresses, and physical memory of the second processor is mapped to the second portion of virtual addresses.

Example 8 includes the subject matter of example 7, where the address translation client is further to: send a region query for the virtual address space of the process; and receive a region assignment listing, where the region assignment listing identifies a plurality of regions of the virtual address space of the process and maps a plurality of processors in a system to respective regions in the plurality of regions, where the first processor device and second processor device are included in the plurality of processors, and the first region and the second region are included in the plurality of regions, where the distributed translation request is sent to the second processor device based on the region assignment listing.

Example 9 includes the subject matter of example 8, where the system includes a root complex, and the region request is sent to and the region assignment listing is received from the root complex.

Example 10 includes the subject matter of any one of examples 1-9, where the distributed address translation request includes a first packet based on a Peripheral Component Interconnect Express (PCIe)-based protocol, and the response to the distributed address translation request includes a second packet based on the PCIe-based protocol.

Example 11 is a method including: identifying that a first processor device is associated with a first region of virtual memory of a process and that a second processor device is associated with a second region of the virtual memory of the process, where a first portion of virtual addresses are included in the first region and a second portion of virtual addresses are included in the second region; sending a request from the first processor device to the second processor device to translate a first virtual address in the virtual memory, where the first virtual address is included in the second region, and the request is sent to the second processor based on identifying the second process is associated with the second region; receiving a response to the request, where the response identifies that a first physical address of the second processor device is mapped to the first virtual address; and updating a page table of the first processor device based on the response, where the page table includes local entries and remote entries, the local entries map virtual addresses in the first region to physical addresses in physical memory of the first processor device, and the remote entries map regions of the virtual memory to physical addresses in addresses of other processor devices in a system, where the other processor devices include the second processor device.

Example 12 includes the subject matter of example 11, further including: determining a particular physical address corresponding to a particular virtual address of a particular page using the page table; and sending a page request to fetch the page from memory based on the particular physical address.

Example 13 includes the subject matter of example 12, where the page is fetched from either the physical memory of the first processor device or the physical memory of the second processor device.

Example 14 includes the subject matter of example 12, where the page is fetched from pooled memory, and mappings of virtual addresses of the virtual memory are mapped to physical addresses in the pooled memory in the page table.

Example 15 includes the subject matter of any one of examples 11-14, further including: receiving, from the second processor device at the first processor device, a request to translate a second virtual address, where the second virtual address is included in the first region; determining, at the first processor device, from the page table, that the second virtual address maps to a second physical address in physical memory of the first processor device; sending, from the first processor device to the second processor device, a translation response to the request to translate the second virtual address, where the translation response identifies that the second virtual address maps to the second physical address, where the translation response is for use in updating a page table of the second processor device.

Example 16 includes the subject matter of any one of example 11-15, where identifying that the first processor device is associated with the first region of virtual memory of the process and that the second processor device is associated with the second region of the virtual memory of the process includes: sending a region query to a host, where the region query is associated with the virtual memory of the process; and receiving a region query response including a listing mapping processor devices in a system to regions of the virtual memory of the process.

Example 17 includes the subject matter of any one of examples 11-16, where the request includes a first packet according to a PCIe-based protocol and the response includes a second packet according to the PCIe-based protocol.

Example 18 includes the subject matter of any one of examples 11-17, where the first processor device is of a different type than the second processor device.

Example 19 includes the subject matter of any one of examples 11-18, where the first processor device is connected to the second processor device by a fabric within a distributed computing architecture.

Example 20 is a system including means to perform the method of any one of examples 11-19.

Example 21 includes the subject matter of example 20, where the means include a non-transitory computer-readable storage medium with instructions stored thereon, the instructions executable by a machine to cause the machine to perform at least a portion of the method of any one of examples 11-19.

Example 22 is a system including: a first processing unit including: processing circuitry; first physical memory; memory management circuitry to maintain a first page table corresponding to virtual memory of a program; and a second processing unit including: processing circuitry; second physical memory; memory management circuitry to maintain a second page table corresponding to the virtual memory of the program, where a first portion of virtual addresses of the virtual memory are mapped to physical addresses of the first physical memory and a second portion of virtual addresses of the virtual memory are mapped to physical addresses of the second physical memory.

Example 23 includes the subject matter of example 22, where the memory management circuitry of the first processing unit includes: address translation server circuitry to handle queries of the first portion of the virtual addresses; and address translation client circuitry to query the second processing unit for virtual address mappings for the second portion of virtual addresses.

Example 24 includes the subject matter of any one of examples 22-23, where the first processing unit and the second processing units are interconnected by a fabric in a distributed computing environment.

Example 25 includes the subject matter of example 24, where the first processing unit is of a different type than the second processing unit.

Example 26 includes the subject matter of example 25, where the first processing unit includes a central processing unit, and the second processing unit includes one of a graphics processing unit, data processing unit, or an infrastructure processing unit.

Example 27 includes the subject matter of example 24, where the program is to utilize the first processing unit and the second processing unit during execution.

Example 28 includes the subject matter of example 27, where the program includes one of a machine learning or artificial intelligence program.

Example 29 includes the subject matter of any one of examples 23-28, where the memory management circuitry of the second processing unit includes: address translation client circuitry to query the first processing unit for virtual address mappings for the first portion of virtual addresses.

Example 30 includes the subject matter of any one of examples 22-29, further including fabric-attached memory, where a portion of virtual addresses in the first portion of virtual addresses are mapped to physical addresses of the fabric-attached memory.

Example 31 includes the subject matter of example 30, where the fabric-attached memory includes a pool of memory included of physical memory from a plurality of devices in the system.

Example 32 includes the subject matter of any one of examples 30-31, where the fabric-attached memory is implemented using a CXL-based protocol.

Example 33 includes the subject matter of any one of examples 22-32, where the second processing unit includes host circuitry to: receive a region query from the first processing unit relating to the virtual memory of the program; identify a region mapping for the virtual memory of the program, where the region mapping identifies that physical memory of the first processing unit is to be mapped to the first portion of virtual addresses and that physical memory of the second processing unit is to be mapped to the second portion of virtual addresses; and return the region mapping to the first processing unit as a response to the region query.

Example 34 includes the subject matter of any one of examples 22-33, where the first page table includes local entries corresponding to virtual address mappings to physical memory of the first processing unit and remote entries corresponding to virtual address mappings to physical memory owned by processing units other that the first processing unit.

Example 35 includes the subject matter of example 34, where the second page table includes local entries corresponding to virtual address mappings to physical memory of the second processing unit and remote entries corresponding to virtual address mappings to physical memory owned by processing units other that the second processing unit.

Example 36 includes the subject matter of any one of examples 22-35, further including: a third processing unit connected to the first processing unit and the second processing unit by a fabric, the third processing unit including: processing circuitry; third physical memory; memory management circuitry to maintain a third page table corresponding to the virtual memory of the program, where a third portion of virtual addresses of the virtual memory are mapped to physical addresses of the third physical memory.

Example 37 includes the subject matter of any one of examples 22-36, where the system includes a server.

Example 38 includes the subject matter of any one of examples 22-36, where the system includes a data center cluster.

Example 39 includes the subject matter of any one of examples 22-36, where the system includes a system on chip.

Example 40 includes the subject matter of any one of examples 22-39, where addresses translation requests and responses handled by either the memory management circuitry of the first processing unit or the second processing unit is according to a message format defined in a PCIe-based protocol.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1-25. (canceled)

26. An apparatus comprising:
a first processor device;
first physical memory to store a page table associated with a virtual address space of a process, wherein a first portion of the virtual address space is mapped to the first physical memory and a second portion of the virtual address space is mapped to a second physical memory of a second processor device;
a memory management unit comprising:
an address translation client to:
send a distributed address translation request to a second processor device, wherein the distributed address translation request identifies a second virtual memory address associated with the process;
receive a response to the distributed address translation request, wherein the response to the distributed address translation request identifies that a second physical memory address of a second physical memory associated with the second processor device is mapped to the second virtual memory address; and
add a mapping of the second virtual memory address to the second physical memory address in the page table.

27. The apparatus of claim 26, wherein the memory management unit further comprises:
an address translation server to:
receive a request to translate a first virtual memory address in the first portion of the virtual address space into a physical address of the first physical memory;
determine, from the page table, a mapping of the first virtual memory address to a first physical memory address of the first physical memory; and
return the first physical memory address as a response to the request.

28. The apparatus of claim 26, wherein the first physical memory address addresses a first page of data within the first physical memory, and the second physical memory address addresses a second page of data within the second physical memory.

29. The apparatus of claim 26, wherein the first processor device and the second processor device are interconnected in a distributed computing architecture, and virtual memory for the computing architecture is distributed between memory of at least the first processor device and the second processor device.

30. The apparatus of claim 29, wherein the distributed computing architecture comprises pooled memory shared within the distributed computing architecture, and the memory of the first processor device comprises the first physical memory and at least a portion of the pooled memory.

31. The apparatus of claim 26, wherein the first processor device is associated with a first region of virtual address space of the process and the second processor device is associated with a second region of virtual address space of the process, wherein a first portion of virtual addresses in the virtual address space of the process are included in the first region, a second portion of virtual addresses in the virtual address space of the process are included in the second region, wherein physical memory of the processor is mapped to the first portion of virtual addresses, and physical memory of the second processor is mapped to the second portion of virtual addresses.

32. The apparatus of claim 31, wherein the address translation client is further to:
send a region query for the virtual address space of the process; and
receive a region assignment listing, wherein the region assignment listing identifies a plurality of regions of the virtual address space of the process and maps a plurality of processors in a system to respective regions in the plurality of regions, wherein the first processor device and second processor device are included in the plurality of processors, and the first region and the second region are included in the plurality of regions,
wherein the distributed translation request is sent to the second processor device based on the region assignment listing.

33. The apparatus of claim 32, wherein the system comprises a root complex, and the region request is sent to and the region assignment listing is received from the root complex.

34. The apparatus of claim 26, wherein the distributed address translation request comprises a first packet based on a Peripheral Component Interconnect Express (PCIe)-based protocol, and the response to the distributed address translation request comprises a second packet based on the PCIe-based protocol.

35. A method comprising:
identifying that a first processor device is associated with a first region of virtual memory of a process and that a second processor device is associated with a second region of the virtual memory of the process, wherein a first portion of virtual addresses are included in the first region and a second portion of virtual addresses are included in the second region;
sending a request from the first processor device to the second processor device to translate a first virtual address in the virtual memory, wherein the first virtual address is included in the second region, and the request is sent to the second processor based on identifying the second process is associated with the second region;
receiving a response to the request, wherein the response identifies that a first physical address of the second processor device is mapped to the first virtual address;
updating a page table of the first processor device based on the response, wherein the page table comprises local entries and remote entries, the local entries map virtual addresses in the first region to physical addresses in physical memory of the first processor device, and the remote entries map regions of the virtual memory to physical addresses in addresses of other processor devices in a system, wherein the other processor devices comprise the second processor device.

36. The method of claim 35, further comprising:
receiving, from the second processor device at the first processor device, a request to translate a second virtual address, wherein the second virtual address is included in the first region;
determining, at the first processor device, from the page table, that the second virtual address maps to a second physical address in physical memory of the first processor device;
sending, from the first processor device to the second processor device, a translation response to the request to translate the second virtual address, wherein the translation response identifies that the second virtual address maps to the second physical address, wherein the translation response is for use in updating a page table of the second processor device.

37. A system comprising:
a first processing unit comprising:
processing circuitry;
first physical memory;
memory management circuitry to maintain a first page table corresponding to virtual memory of a program; and
a second processing unit comprising:
processing circuitry;
second physical memory;
memory management circuitry to maintain a second page table corresponding to the virtual memory of the program,
wherein a first portion of virtual addresses of the virtual memory are mapped to physical addresses of the first physical memory and a second portion of virtual addresses of the virtual memory are mapped to physical addresses of the second physical memory.

38. The system of claim 37, wherein the memory management circuitry of the first processing unit comprises:
address translation server circuitry to handle queries of the first portion of the virtual addresses; and
address translation client circuitry to query the second processing unit for virtual address mappings for the second portion of virtual addresses.

39. The system of claim 37, wherein the first processing unit and the second processing units are interconnected by a fabric in a distributed computing environment, and the first processing unit is of a different type than the second processing unit.

40. The system of claim 39, wherein the first processing unit comprises a central processing unit, and the second processing unit comprises one of a graphics processing unit, data processing unit, or an infrastructure processing unit.

41. The system of claim 37, wherein the program is to utilize the first processing unit and the second processing unit during execution.

42. The system of claim 41, wherein the program comprises one of a machine learning or artificial intelligence program.

43. The system of claim 37, further comprising fabric-attached memory, wherein a portion of virtual addresses in the first portion of virtual addresses are mapped to physical addresses of the fabric-attached memory.

44. The system of claim 43, wherein the fabric-attached memory comprises a pool of memory comprised of physical memory from a plurality of devices in the system.

45. The system of claim 37, wherein the second processing unit comprises host circuitry to:
receive a region query from the first processing unit relating to the virtual memory of the program;
identify a region mapping for the virtual memory of the program, wherein the region mapping identifies that physical memory of the first processing unit is to be mapped to the first portion of virtual addresses and that physical memory of the second processing unit is to be mapped to the second portion of virtual addresses; and
return the region mapping to the first processing unit as a response to the region query.
